(19) United States
(12) Patent Application Publication
(10) Pub. No.: US 2026/0359073 A1
(43) Pub. Date: Nov. 12, 2026

(54) METHOD AND APPARATUS FOR PROCESSING PLUGIN-BASED TASK

(71) Applicant: BEIJING BAIDU NETCOM SCIENCE TECHNOLOGY CO., LTD., Beijing (CN)

(72) Inventors: Zhimin Zhang, Beijing (CN); Haohao Gu, Beijing (CN); Jun Huo, Beijing (CN); Jialin Li, Beijing (CN); Xiaoguang Hu, Beijing (CN)

(73) Assignee: BEIJING BAIDU NETCOM SCIENCE TECHNOLOGY CO., LTD., Beijing (CN)

(21) Appl. No.: 19/720,416

(22) Filed: Jun. 25, 2026

(30) Foreign Application Priority Data
Mar. 19, 2026 (CN) 202610343561.4

(51) Int. Cl. G06F 9/445; G06N 20/00

(52) U.S. Cl. CPC G06F 9/44526; G06N 20/00

(57) ABSTRACT

A method for processing a plugin-based task in an intelligent machine learning algorithm design includes: registering first and second plugins in an execution process of a target task, wherein the execution process of the target task includes generating a task processing result based on historical data related to the target task and a large model, and performing a next round of task processing based on a feedback result of the task processing result; in response to completing execution of a step to which the first plugin subscribes, determining whether to trigger expert participation in decision-making according to a first running state of the target task by invoking the first plugin; and in response to completing execution of a step to which the second plugin subscribes, determining whether to trigger training of the large model according to a second running state of the target task by invoking the second plugin.

### CROSS-REFERENCE TO RELATED APPLICATION

The present application is based upon and claims priority to Chinese Patent Application No. 2026103435614, filed on Mar. 19, 2026, the entire contents of which are incorporated herein by reference.

### TECHNICAL FIELD

The present disclosure relates to the technical fields such as artificial intelligence (AI), large models, and natural language processing, and specifically to a method and an apparatus for processing a plugin-based task.

### BACKGROUND

With the application of large language models in fields of intelligent decision-making and automated optimization, automated iteration systems centered on automatic generation of solutions, execution implementation, and feedback effect evaluation are gradually developed.

However, such systems generally adopt a single closed-loop evolution process, for example, automatic generation of solutions, automatic construction of execution logics, automatic evaluation of execution results, and directly starting a next round of iteration based on a current round of evaluation. The single closed-loop evolution process relies entirely on system autonomous iteration, which easily leads to problems such as local optima, ineffective repeated iterations, and disconnection from actual application goals.

### SUMMARY

According to a first aspect of the present disclosure, a method for processing a plugin-based task in an intelligent machine learning algorithm design is provided, including: registering a first plugin and a second plugin in an execution process of a target task, in which the execution process of the target task includes generating a task processing result based on historical data related to the target task and a large model, and performing a next round of task processing based on a feedback result of the task processing result; in response to completing execution of a step to which the first plugin subscribes, determining whether to trigger expert participation in decision-making according to a first running state of the target task by invoking the first plugin; and in response to completing execution of a step to which the second plugin subscribes, determining whether to trigger training of the large model according to a second running state of the target task by invoking the second plugin.

According to a second aspect of the present disclosure, an electronic device is provided, including: at least one processor; and a memory communicatively coupled to the at least one processor, in which the memory stores instructions that, when executable by the at least one processor, cause the at least one processor to perform the above method for processing a plugin-based task as described in the first aspect of the present disclosure.

According to a third aspect of the present disclosure, a non-transitory computer-readable storage medium for storing computer instructions is provided, in which the computer instructions is configured to cause a computer to perform the above method for processing a plugin-based task as described in the first aspect of the present disclosure.

### BRIEF DESCRIPTION OF THE DRAWINGS

The accompanying drawings are used for a better understanding of the disclosure and do not constitute a limitation of the disclosure.

FIG. 1 is a flowchart of a method for processing a plugin-based task according to the embodiments of the present disclosure.

FIG. 2 is a flowchart of another method for processing a plugin-based task according to the embodiments of the present disclosure.

FIG. 3 is a flowchart of another method for processing a plugin-based task according to the embodiments of the present disclosure.

FIG. 4 is an example diagram of a method for processing a plugin-based task according to the embodiments of the present disclosure.

FIG. 5 is a block diagram of an apparatus for processing a plugin-based task according to the embodiments of the present disclosure.

FIG. 6 is a block diagram illustrating an example electronic device 600 that may be used to implement the embodiments of the present disclosure.

### DETAILED DESCRIPTION

Exemplary embodiments of the disclosure are described hereinafter in conjunction with the accompanying drawings, which include various details of the embodiments of the disclosure in order to aid in understanding, and should be considered exemplary only. Similarly, descriptions of well-known features and structures are omitted from the following description for the sake of clarity and brevity.

In the related art, in order to solve the problems of local optima, ineffective repeated iterations, and disconnection from actual application goals that may be caused by a single closed-loop autonomous iteration of an automated iteration system, a human-in-the-loop capability is introduced into the automated iteration system, by incorporating prior knowledge of experts in the field into the iteration process, so as to prevent the system from falling into local optima or ineffective iterations, and ensure a reasonable iteration direction and a trusted iteration process. Human-in-the-loop refers to combining human decision-making, judgment and machine automation processing during the operation of an intelligent system to form a closed-loop working mode with a human in the loop.

In addition, in the related art, in order to solve the problem that the model capability is fixed during the operation of an automated iteration system and it is difficult to continuously optimize based on real-time data, a test-time-training capability is introduced into the automated iteration system, which allows the model to continuously adapt and optimize using real-time feedback during an actual inference process, thus improving generalization ability and robustness for different task scenarios. Test-time-training refers to that, during a model inference phase (rather than a training phase), model parameters are dynamically fine-tuned and optimized using current test data (usually unlabeled) so as to improve the output accuracy.

However, the way of introducing the above capabilities into the automated iteration system is tightly coupled introducing. For example, when introducing the human-in-the-loop capability, it is often necessary to change the blocking logic of the execution process; and when introducing the test-time-training capability, it is often necessary to modify a model calling interface and a state management structure. This “invasive extension” method seriously reduces system maintainability.

Moreover, when introducing the human-in-the-loop capability, an expert participation mechanism is fixed and tightly coupled with specific process nodes, making it difficult to dynamically enable or disable according to an actual execution process; and when introducing the test-time-training capability, model training is embedded in links of model calling, model inference and model execution, and deeply binds with an inference logic, which makes it difficult to flexibly configure the model training in different tasks.

As for the above problems, the present disclosure provides a method and an apparatus for processing a plugin-based task.

The method and the apparatus for processing a plugin-based task according to the embodiments of the present disclosure are described below with reference to the accompanying drawings.

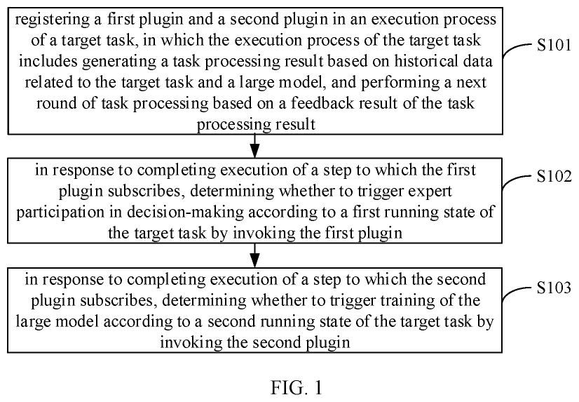

FIG. 1 is a flowchart of a method for processing a plugin-based task according to the embodiments of the present disclosure.

As shown in FIG. 1, the method for processing a plugin-based task may include the following steps at S101 to S103.

At S101, a first plugin and a second plugin are registered in an execution process of a target task, in which the execution process of the target task includes generating a task processing result based on historical data related to the target task and a large model, and a next round of task processing is performed based on a feedback result of the task processing result.

It needs to be noted that the execution subject of the method for processing a plugin-based task in the embodiments of the present disclosure may be a hardware device with data processing capabilities and/or necessary software required to drive the hardware device to work. In an example, the execution subject may include a server, a user terminal, and other intelligent devices. In an example, the user terminal includes but is not limited to a mobile phone, a computer, a smart voice interaction device, etc. In an example, the server includes but is not limited to a web server, an application server, or a server of a distributed system, or a server combined with a blockchain, etc. The embodiments of the present disclosure do not make specific limitations.

The target task is any task that invokes a large model for task processing, for example, a task that invokes a large model for scientific research.

In a case that the target task is the task that invokes a large model for scientific research, an execution process of the target task may be, for example, based on existing historical scientific research data, generating new scientific research data by performing simulation reasoning via the large model, performing or simulating execution based on generated new scientific research data, obtaining a feedback result, and performing a next round of scientific research based on the feedback result.

The large model is any large model with data understanding and generation capabilities, for example, a large language model, a multimodal large model, etc.

In some embodiments, the first plugin and the second plugin are registered in the execution process of the target task via a plugin registration mechanism.

The first plugin and the second plugin are plugins generated by pluginizing a corresponding capability. For example, the first plugin may be a plugin generated by developing the human-in-the-loop capability according to a unified plugin interface, and the second plugin may be a plugin generated by developing the test-time-training capability according to the unified plugin interface.

As an example, in order to achieve flexible expansion of the above capabilities of the automated iteration system, a plurality of functional plugins may be added without modifying codes of core control module, for example, the first plugin and the second plugin may be added. The functional plugins are all developed based on the unified plugin interface and are connected to the core control modules of the system via the plugin registration mechanism. The functional plugin has at least the following capabilities:

Event subscription mechanism: the functional plugin may subscribe to a specified execution stage in the iteration process, such as a generation stage, an evaluation stage, etc.;

Data interception mechanism: after execution of the specified execution stage is completed, the functional plugin may obtain system operation data to process or enhance the system operation data; and

Result modification mechanism: the functional plugin may adjust or supplement the obtained system operation data, thus affecting a subsequent iteration process.

Thus, the system may, via the plugin registration mechanism, enable the functional plugin to perform event subscription, data interception, and result modification at the same or different stages of the iteration process, thus achieving flexible expansion of the iteration process.

At S102, in response to completing execution of a step to which the first plugin subscribes, whether to trigger expert participation in decision-making is determined according to a first running state of the target task by invoking the first plugin.

The first running state is a running state of the target task after the execution of the step to which the first plugin subscribes is completed. The first running state is determined based on task data of the target task after the execution of the step to which the first plugin subscribes is completed.

In some embodiments, when registering the first plugin in the execution process of the target task, the first plugin is configured to be triggered based on a specific step in the execution process of the target task via the event subscription mechanism, and then when the execution of the step to which the first plugin subscribes is completed, a current running state of the target task is obtained by invoking the first plugin, so as to dynamically decide whether to trigger the expert participation in decision-making based on a real-time running state of the target task.

As an example, in order to solve the problem that the expert participation mechanism is fixed and it is difficult to dynamically adjust according to the actual execution process in the automated iteration system, the human-in-the-loop capability may be encapsulated into the first plugin. After the step to which the first plugin subscribes is executed, the first plugin dynamically decides whether to trigger the expert participation in decision-making according to the current running state of the target task. As such, it is achieved that human-in-the-loop is decoupled from a core iteration process of the system, and without modifying core codes in the system, it is possible to flexibly decide whether to introduce the expert participation in decision-making according to the real-time running state of the task, thus introducing human prior knowledge while maintaining the automation efficiency, preventing the system from falling into the local optima or repeated ineffective iterations, and ensuring the rationality and controllability of an iteration direction.

At S103, in response to completing execution of a step to which the second plugin subscribes, whether to trigger training of the large model is determined according to a second running state of the target task by invoking the second plugin.

The second running state is a running state of the target task after the execution of the step to which the second plugin subscribes is completed. The second running state is determined based on task data of the target task after the execution of the step to which the second plugin subscribes is completed.

In some embodiments, when registering the second plugin in the execution process of the target task, the second plugin is configured to be triggered based on a specific step in the execution process of the target task via the event subscription mechanism, and then when the execution of the step to which the second plugin subscribes is completed, a current running state of the target task is obtained by invoking the second plugin, so as to dynamically decide whether to trigger training of the large model based on a real-time running state of the target task.

As an example, in order to solve the problem that model training and inference logic are deeply bound and it is difficult to flexibly configure the model training in different tasks in the automated iteration system, the test-time-training capability may be encapsulated into the second plugin. After the step to which the second plugin subscribes is executed, the second plugin dynamically decides whether to trigger training of the large model according to the current running state of the target task. As such, the test-time-training capability is detached from a fixed model calling process, a flexible configuration of enabling or disabling the timing according to requirements of different tasks may be achieved without modifying the core codes in the system, improving the scalability and adaptability of a system architecture, while allowing the large model to be dynamically optimized based on the real-time running state of the task, alleviating the problems of overfitting and insufficient generalization ability, and ensuring the targeting and flexibility of model optimization during the iteration process.

In the method for processing a plugin-based task provided in the embodiments of the present disclosure, by registering the first plugin and the second plugin in the execution process of the target task, modular access of functions may be achieved, which improves the system scalability and reusability; in which the first or second plugin is triggered to be invoked after the execution of the step to which the first or second plugin subscribes is completed, which may decouple functions implemented by the plugins from the task execution process, and avoid the rigidity caused by hard coding; the first plugin dynamically judges whether to trigger the expert participation in decision-making according to the first running state of the target task, which may achieve on-demand and flexible human-in-the-loop, both integrating prior knowledge for experts in the field and avoiding unnecessary manual intervention, and may improve the controllability and rationality of target task execution; the second plugin dynamically judges whether to trigger training of the large model according to the second running state of the target task, which may decouple model training from the fixed model calling process, enable adaptive triggering of model optimization based on an actual execution status of the task, enhance the generalization ability and robustness of the large model for different task scenarios, and improve the efficiency and credibility of the target task execution.

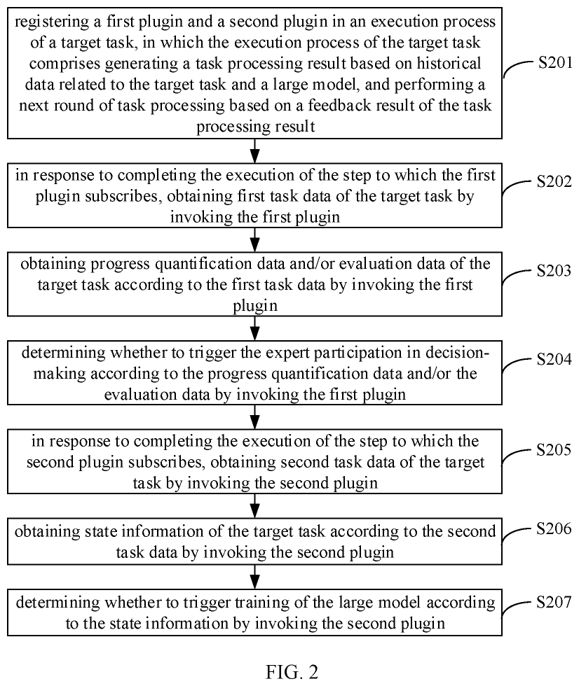

FIG. 2 is a flowchart of another method for processing a plugin-based task according to the embodiments of the present disclosure.

As shown in FIG. 2, the method for processing a plugin-based task may include the following steps at S201 to S207.

At S201, a first plugin and a second plugin are registered in an execution process of a target task, in which the execution process of the target task includes generating a task processing result based on historical data related to the target task and a large model, and performing a next round of task processing based on a feedback result of the task processing result.

For the explanation of S201, reference may be made to the relevant description in any embodiment of the present disclosure, and will not be repeated here.

In some embodiments, the target task is a scientific research task; from historical data related to the scientific research task, target scientific research data that matches a research objective of the target task is determined; and the task processing result is generated by invoking the large model to perform simulation reasoning based on the target scientific research data.

Based on the degree of matching between scientific research data in the historical data related to the scientific research task and the research objective of the target task, the target scientific research data may be determined from the historical data. The determined target scientific research data is a starting point of a round of task processing.

The target scientific research data may be used as prompt information to invoke the large model to perform simulation reasoning and generate new scientific research data as the task processing result.

As an example, the target task may be, for example, an intelligent experiment design task. Historical data related to the experiment design may be retrieved from a database or vector storage, and via a similarity matching or a value evaluation mechanism, a basic experiment solution S with a high reference value is selected as the target scientific research data. Then, using the basic experiment solution S as a prompt, a large language model is called for reasoning and generation, and outputting a new scientific hypothesis H and a corresponding experiment solution E. The scientific hypothesis H and the corresponding experiment solution E output by the large language model are task processing results in a task processing process of the intelligent experiment design task.

By accurately matching, from the historical data related to the scientific research task, target scientific research data that is consistent with the research objective of the target task, and then generating the task processing result by invoking the large model to perform simulation reasoning based on the data, the large model may be used to efficiently generate a scientific research result, shorten a scientific research cycle, expand a scientific research concept, and promote the speed and quality of scientific discovery.

In some embodiments, similarities between pieces of scientific research data in the historical data and the research objective are determined; a piece of scientific research data in the historical data whose similarity is higher than a preset similarity threshold is taken as the target scientific research data; and/or evaluation scores are determined by performing value evaluation on pieces of scientific research data in the historical data according to the research objective; and a piece of scientific research data in the historical data whose evaluation score is higher than a preset score threshold is taken as the target scientific research data.

The historical data records a plurality of types of scientific research data, and a plurality of pieces of scientific research data are included in a same type of scientific research data. Based on the content of each piece of scientific research data, its similarity to the research objective of the target task may be determined, so as to determine the target scientific research data from the plurality of pieces of scientific research data based on the similarity. And/or, based on the research objective of the target task, the value evaluation may be performed on the each piece of scientific research data, so as to determine the target scientific research data from the plurality of pieces of scientific research data based on the evaluation score.

Key information may be extracted from the each piece of scientific research data, and based on a semantic similarity between the extracted key information and the research objective of the target task, the target scientific research data may be determined from the plurality of pieces of scientific research data.

The value evaluation may be performed on the each piece of scientific research data from a plurality of dimensions such as innovation, feasibility, and potential impact.

By screening the scientific research data in the historical data via similarity matching and/or value evaluation, scientific research data that is highly matched with a current research objective or has a high potential value may be accurately determined, which improves the accuracy and reliability of selecting the target scientific research data, provides reliable prior knowledge for a subsequent model reasoning process, and improves the targeting and overall efficiency of scientific research.

In some embodiments, the execution process of the target task further includes: obtaining an execution feedback result or a simulation feedback result of the task processing result; and taking the execution feedback result or the simulation feedback result as the feedback result of the task processing result.

If the task processing result generated by the large model may be executed, relevant equipment is controlled to execute the task processing result, and real-time data during the execution process is collected as the execution feedback result; in a case that the task processing result generated by the large model does not satisfy an execution condition, simulation is performed on the task processing result, and a simulation result is output as the simulation feedback result.

As an example, for the above example where the target task is an intelligent experiment design task, the experiment solution E generated by the large language model may be executed or simulated and evaluated, and an experiment feedback result F is obtained via a simulation environment, a code execution framework or an agent evaluation mechanism. The experiment feedback result F is a feedback result of the task processing result in a task processing process of the intelligent experiment design task.

By obtaining the execution feedback result or the simulation feedback result of the task processing result and using it as the feedback result of the task processing result, closed-loop verification and effect tracking of the task processing result generated by the large model may be achieved, the rationality and feasibility of the data generated by the large model may be timely learned, objective data support may be provided for a subsequent iteration process, and the accuracy and iteration efficiency of task processing may be improved.

At S202, in response to completing the execution of the step to which the first plugin subscribes, first task data of the target task is obtained by invoking the first plugin.

The first task data is task data of the target task after the execution of the step to which the first plugin subscribes is completed.

In some embodiments, when registering the first plugin in the execution process of the target task, the first plugin is configured to be triggered based on a specific step in the execution process of the target task via the event subscription mechanism, and then when the execution of the step to which the first plugin subscribes is completed, current task data of the target task is obtained by invoking the first plugin.

At S203, progress quantification data and/or evaluation data of the target task are obtained according to the first task data by invoking the first plugin.

The progress quantification data are used to quantify a progress state of the target task, and the evaluation data includes an uncertainty indicator of a current task processing result of the target task.

In some embodiments, the progress quantification data includes at least one of: progress indication data, in which the progress indication data indicates whether the target task makes progress within a preset time period; improvement amplitude data, in which the improvement amplitude data includes an improvement amplitude value of the current task processing result of the target task; or processing efficiency data, in which the processing efficiency data includes a current processing efficiency of the target task.

Subdividing the progress quantification data into progress indication data, the improvement amplitude data and the processing efficiency data may provide a comprehensive, accurate and objective quantitative description of the target task from three dimensions: whether there is a progress, how much improvement is made, and whether the efficiency is high or low, which makes the task processing process monitorable, measurable and comparable.

The uncertainty indicator may be, for example, a perplexity or other uncertainty indicator determined by the large model for its generated result.

In some embodiments, the first plugin is invoked to monitor the progress state of the target task based on the obtained current task data of the target task, and to obtain the progress quantification data and/or the evaluation data of the target task.

At S204, whether to trigger the expert participation in decision-making is determined according to the progress quantification data and/or the evaluation data by invoking the first plugin.

In some embodiments, the first plugin is invoked to determine to trigger the expert participation in decision-making in a case that the progress quantification data satisfies a corresponding trigger condition; and/or, the first plugin is invoked to determine to trigger the expert participation in decision-making in a case that the evaluation data exceeds a corresponding preset threshold.

The corresponding trigger condition may be preset for the progress quantification data, and/or a corresponding threshold may be preset for the evaluation data, and then when the progress quantification data satisfies the corresponding trigger condition, and/or the evaluation data exceeds the corresponding preset threshold, the first plugin is invoked to determine to trigger the expert participation in decision-making.

By invoking the first plugin to automatically determine to trigger the expert participation in decision-making when the progress quantification data satisfies the corresponding trigger condition and/or the evaluation data exceeds the corresponding preset threshold, intelligent risk warning and decision intervention for the target task may be achieved, a timely introduction of expert judgment may be ensured when a task progress is abnormal or a result uncertainty is too high, so as to improve the scientificity and reliability of task processing.

In some embodiments, the corresponding trigger condition of the progress quantification data includes at least one of: the progress indication data indicating that the target task makes no progress within the preset time period; the improvement amplitude value indicated by the improvement amplitude data being lower than a preset amplitude threshold; or the processing efficiency data indicating that a processing efficiency of the target task is decreased.

The progress indication data indicating that the target task makes no progress within the preset time period means that the task progress is stagnant for a long time.

The first plugin may be invoked to determine to trigger the expert participation in decision-making when at least one of the following situations is detected: the task progress being stagnant for a long time, an improvement amplitude of the task processing result being lower than the preset amplitude threshold, or the processing efficiency being decreased.

By setting the progress indication data indicating no progress, the improvement amplitude being lower than the preset threshold, and the processing efficiency being decreased as trigger conditions for the progress quantification data, an abnormal state of the target task may be accurately identified from three key dimensions including the task progress, the optimization effect, and the execution efficiency, ensuring that the expert participation in decision-making is triggered when the task is stagnant, the optimization is weak, or the efficiency is decreased, which not only ensures the efficient utilization of expert resources but also timely corrects a task processing direction.

At S205, in response to completing the execution of the step to which the second plugin subscribes, second task data of the target task is obtained by invoking the second plugin.

The second task data is task data of the target task after the execution of the step to which the second plugin subscribes is completed.

In some embodiments, when registering the second plugin in the execution process of the target task, the second plugin is configured to be triggered based on a specific step in the execution process of the target task via the event subscription mechanism, and then when the execution of the step to which the second plugin subscribes is completed, current task data of the target task is obtained by invoking the second plugin.

At S206, state information of the target task is obtained according to the second task data by invoking the second plugin.

The state information includes at least one of: statistics of target task data during the execution process of the target task, a feedback result of a current task processing result of the target task, or problem domain information of the target task.

As an example, the target task data may be, for example, the feedback result of the task processing result.

In some embodiments, the second plugin is invoked to monitor the running state of the target task based on the obtained current task data of the target task, and to obtain the state information of the target task.

At S207, whether to trigger training of the large model is determined according to the state information by invoking the second plugin.

In some embodiments, determining to trigger training of the large model by invoking the second plugin in a case that the state information satisfies at least one of: the statistics of the target task data during the execution process of the target task exceeding a preset statistic threshold; the feedback result of the current task processing result of the target task indicating that an execution success rate of the current task processing result is lower than a preset success rate threshold; or the problem domain information of the target task indicating that a problem domain of the target task is changed.

As an example, for the above example where the target task is an intelligent experiment design task, the second plugin may be invoked to determine to trigger training of the large model in a case that at least one of the following situations is detected: a situation where a certain number of experiment feedback results F are accumulated; a situation where the experiment feedback result F indicates that an execution success rate of the experiment solution E generated by the large language model is lower than the preset success rate threshold; or a situation where it is detected that the intelligent experiment design task enters a new problem domain.

By invoking the second plugin to automatically determine to trigger training of the large model in a case that the statistics of the target task data exceeds the threshold, the execution success rate of the task processing result is too low, or the problem domain is changed, dynamic adaptation between the task processing process and the model capability may be achieved, and the reasoning and generation accuracy of the large model in a corresponding task scenario may be timely improved.

In the method for processing a plugin-based task provided in the embodiments of the present disclosure, after the execution of the step to which the first plugin subscribes is completed, the first plugin is invoked to obtain the first task data, and then obtain the progress quantification data and/or the evaluation data of the target task by parsing, and it is determined whether to trigger the expert participation in decision-making according to the progress quantification data and/or the evaluation data, which achieves automated connection of a whole process from task data collection, data analysis to expert intervention judgment, is able to grasp the task progress and outcome uncertainty in real time, objectively and accurately, improves the rationality of the timing for triggering the expert participation in decision-making, and ensures stable, controllable and efficient advancement of the task processing process. After the execution of the step to which the second plugin subscribes is completed, the second plugin is invoked to obtain the second task data, and then obtain the state information of the target task by parsing, and it is determined whether to trigger training of the large model according to the progress quantification data and/or the evaluation data, which achieves automated connection of a whole process from task data collection, state perception to model training triggering, is able to dynamically adapt to the capability of the large model according to the running state of the target task, improves the adaptability of the large model to different task scenarios, and enhances the adaptive capability and intelligence level of the task processing procedure.

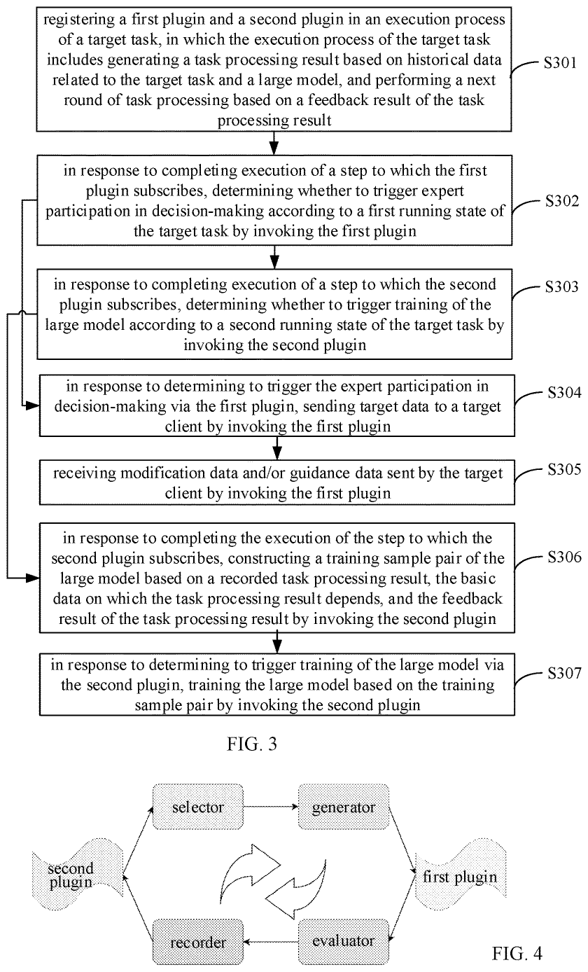

FIG. 3 is a flowchart of another method for processing a plugin-based task according to the embodiments of the present disclosure.

As shown in FIG. 3, the method for processing a plugin-based task may include the following steps at S301 to S307.

At S301, a first plugin and a second plugin are registered in an execution process of a target task, in which the execution process of the target task includes generating a task processing result based on historical data related to the target task and a large model, and performing a next round of task processing based on a feedback result of the task processing result.

At S302, in response to completing execution of a step to which the first plugin subscribes, whether to trigger expert participation in decision-making is determined according to a first running state of the target task by invoking the first plugin.

At S303, in response to completing execution of a step to which the second plugin subscribes, whether to trigger training of the large model is determined according to a second running state of the target task by invoking the second plugin.

For the explanations of S301 to S303, reference may be made to the relevant description in any embodiment of the present disclosure, and will not be repeated here.

At S304, in response to determining to trigger the expert participation in decision-making via the first plugin, target data is sent to a target client by invoking the first plugin.

The target data includes a task processing result generated during any round of task processing and basic data on which the task processing result depends.

The task processing result is generated by the large model, and input data of the large model is the basic data on which the task processing result depends.

The target client is a client capable of enabling interactive communication with an expert, for example, a client for the expert to receive and send emails, a client for the expert to receive and send text messages, etc.

In some embodiments, if the first plugin determines to trigger the expert participation in decision-making during any round of task processing, the first plugin is invoked to push to the target client, the task processing result generated during this round of task processing and the basic data on which the task processing result depends, so that the expert may make strategy correction or direction guidance.

At S305, modification data and/or guidance data sent by the target client are received by invoking the first plugin.

The modification data are obtained by modifying the target data, and the guidance data are determined based on the target data, and the guidance data is used to guide a task processing process of the target task.

As an example, after receiving the target data, the expert may obtain the modification data by directly modifying the target data, and/or, obtain the guidance data by providing guidance on the task processing process of the target task based on the target data, and then the expert may send the modification data and/or the guidance data to the first plugin via the target client. Correspondingly, the modification data and/or the guidance data from the target client may be received by invoking the first plugin.

At S306, in response to completing the execution of the step to which the second plugin subscribes, a training sample pair of the large model is constructed based on a recorded task processing result, the basic data on which the task processing result depends, and the feedback result of the task processing result by invoking the second plugin.

The execution process of the target task further includes: recording the task processing result generated during any round of task processing, basic data on which the task processing result depends, and the feedback result of the task processing result.

In some embodiments, when execution of the step to which the second plugin subscribes is completed, the second plugin may also be invoked to structurally organize the task processing result recorded during this round of task processing, the basic data on which the task processing result depends, and the feedback result of the task processing result, thus forming a new training sample pair.

The training sample pair (which is constructed based on the task processing result recorded during each round of task processing, the basic data on which the corresponding task processing result depends, and the feedback result of the corresponding task processing result) may reflect an actual problem structure of the current target task, thus enhancing the understanding capability of the model to specific problems.

The step to which the second plugin subscribes should be located after the above recording operation.

At S307, in response to determining to trigger training of the large model via the second plugin, the large model is trained based on the training sample pair by invoking the second plugin.

In some embodiments, if during any round of task processing, the second plugin determines to trigger training of the large model, the large model is trained based on a previously constructed training sample pair by invoking the second plugin.

It needs to be noted that in the present disclosure, the second plugin performs the test-time training, that is, during an inference phase of the large model, the training sample pair (unlabeled) is constructed using data generated during the inference process, so that model parameters of the large model are dynamically fine-tuned and optimized, so as to improve the output accuracy of the large model.

Since the second plugin does not determine to trigger training of the large model in every round of task processing, training the large model by invoking the second plugin when the second plugin determines to trigger training of the large model may maintain the operating efficiency while avoiding the over-training.

In the method for processing a plugin-based task provided in the embodiments of the present disclosure, when the first plugin triggers the expert participation in decision-making, the first plugin is invoked to send the target data including the task processing result and the corresponding basic data to the target client, and to receive the modification data and/or the guidance data fed back by the target client, which may achieve a human-in-the-loop closed loop when the task processing is bottlenecked, use expert experience to accurately correct and/or guide a direction of the task processing process, and ensures stable, controllable and efficient advancement of the task processing process. After the execution of the step to which the second plugin subscribes is completed, based on the task processing result recorded in this round of task processing, the corresponding basic data and the corresponding feedback result, the training sample pair of the large model is constructed, which may reflect an actual problem structure of the current target task, may enhance the understanding capability of the model to specific problems, and then when the second plugin triggers training of the large model, training the large model by using the constructed training sample pair may improve the output accuracy and adaptability of the large model.

FIG. 4 is an example diagram of a method for processing a plugin-based task according to the embodiments of the present disclosure.

In FIG. 4, the execution process of the target task is implemented by a selector, a generator, an evaluator, and a recorder. For example, the target task is a scientific research task. The selector is configured to determine, from historical data related to the scientific research task, target scientific research data that matches a research objective of the target task. The generator is configured to generate the task processing result by invoking the large model to perform simulation reasoning based on the target scientific research data. The evaluator is configured to obtain an execution feedback result or a simulation feedback result of the task processing result; and take the execution feedback result or the simulation feedback result as the feedback result of the task processing result. The recorder is configured to uniformly record key data during the above task processing process and store them into a system knowledge base, including the task processing result, the basic data on which the task processing result depends, and the feedback result of the task processing result, to support subsequent retrieval and learning. The basic data on which the task processing result depends is the target scientific research data.

In order to solve the problem that the expert participation mechanism is fixed and it is difficult to dynamically adjust according to the actual execution process in the automated iteration system, the first plugin is registered in the execution process of the target task. As shown in FIG. 4, the first plugin may subscribe to the generator. When the generator completes the execution, whether to trigger expert participation in decision-making is determined according to a first running state of the target task by invoking the first plugin.

As an example, whether to trigger the expert participation in decision-making includes but is not limited to the following two methods:

Progress-aware human-in-the-loop: monitoring the progress state of the target task. When it is detected that the task progress is stagnant for a long time, an improvement amplitude of the task processing result is lower than a preset amplitude threshold, or the processing efficiency is decreased, the first plugin is invoked to determine to trigger the expert participation in decision-making, and the task processing result and the basic data on which the task processing result depends are pushed to the target client, so that the expert may make strategy correction or direction guidance.

Perplexity-aware human-in-the-loop: evaluating, by the generator, a perplexity or other uncertainty indicator of the generated result when generating the task processing result by invoking the large model. When it is detected that an uncertainty of the model output exceeds a preset threshold, the first plugin is invoked to determine to trigger the expert participation in decision-making, and the expert corrects or supplements the model-generated result, thus improving the reliability of the model generated result.

In order to solve the problem that the model training and the inference logic are deeply bound and it is difficult to flexibly configure the model training in different tasks in the automated iteration system, a second plugin is registered in the execution process of the target task. As shown in FIG. 4, the second plugin may subscribe to the recorder. When the recorder completes the execution, whether to trigger training of the large model is determined according to a second running state of the target task by invoking the second plugin.

As an example, the second plugin is configured to perform the following functions:

Feedback-driven training data construction: during the iterative processing of the target task, the second plugin is invoked to obtain the task processing result recorded by the evaluator, the basic data on which the task processing result depends, and the feedback result of the task processing result, and structurally organizes them to construct a new training sample pair. The training sample pair may reflect an actual problem structure of the current target task, thus enhancing the understanding capability of the model to specific problems.

Dynamically triggered training strategy: the second plugin may dynamically determine whether to trigger training of the large model according to the current running state of the target task. The trigger condition includes, for example but not limited to, the following conditions: training is triggered when a certain number of feedback results is accumulated; training is triggered when the feedback result shows that an execution success rate of the model-generated result is lower than a preset success rate threshold; and training is triggered when it is detected that the target task enters a new problem domain.

Online learning and knowledge accumulation: after performing training, the second plugin loads updated model parameters and/or an optimized inference strategy into the large model invoked by the generator, and participates in a subsequent iteration process. At the same time, data samples used during training are also stored in the system knowledge base for future retrieval and model improvement.

The registration of the first plugin and the second plugin may be completed via a plugin register, which is used to manage plugin components. For example, the plugin register may complete such registration and loading of the plugins via a unified interface, enabling the plugins to perform event subscription, data interception or result modification on the execution process of the target task at a specified execution stage, thus achieving function expansion without modifying core codes.

As an example, the method for processing a plugin-based task in FIG. 4 may be applied, for example, in an intelligent machine learning algorithm design scenario. In this scenario, a method execution process may be, for example: defining a goal of a machine learning algorithm design, such as achieving a specific accuracy on a specific task; defining a specific execution logic of the selector, generator, evaluator, and recorder in the machine learning algorithm design scenario; registering the first plugin using the plugin register as needed, for example, the first plugin subscribes to the generator and will be executed after the generator completes the execution; registering the second plugin using the plugin register as needed, for example, the second plugin subscribes to the recorder and will be executed after the recorder completes the execution.

In summary, by dynamically introducing adaptive human-in-the-loop and seamless test-time-training as independent plugins into the task execution process, on-demand mounting of functions may be achieved, which thus achieves a flexible decoupling and free combination of functions without the need to reconstruct core codes of the task. While ensuring both structural compatibility and operational stability, task adaptation capability may be enhanced and adaptive orchestration and self-evolution of different task processes may be achieved.

FIG. 5 is a block diagram of an apparatus for processing a plugin-based task according to the embodiments of the present disclosure.

As shown in FIG. 5, the apparatus 500 for processing a plugin-based task according to the embodiments of the present disclosure includes a registration module 501, a first determination module 502, and a second determination module 503. The registration module 501 is configured to register a first plugin and a second plugin in an execution process of a target task, in which the execution process of the target task includes generating a task processing result based on historical data related to the target task and a large model, and perform a next round of task processing based on a feedback result of the task processing result. The first determination module 502 is configured to, in response to completing execution of a step to which the first plugin subscribes, determine whether to trigger expert participation in decision-making according to a first running state of the target task by invoking the first plugin. The second determination module 503 is configured to, in response to completing execution of a step to which the second plugin subscribes, determine whether to trigger training of the large model according to a second running state of the target task by invoking the second plugin.

In an embodiment of the present disclosure, the first determination module 502 includes: a first obtaining unit, configured to, in response to completing the execution of the step to which the first plugin subscribes, obtain first task data of the target task by invoking the first plugin; a second obtaining unit, configured to obtain progress quantification data and/or evaluation data of the target task according to the first task data by invoking the first plugin, in which the progress quantification data is used to quantify a progress state of the target task, and the evaluation data includes an uncertainty indicator of a current task processing result of the target task; and a first determination unit, configured to determine whether to trigger the expert participation in decision-making according to the progress quantification data and/or the evaluation data by invoking the first plugin.

In an embodiment of the present disclosure, the first determination unit is further configured to: determine to trigger the expert participation in decision-making by invoking the first plugin in a case that the progress quantification data satisfies a corresponding trigger condition; and/or determine to trigger the expert participation in decision-making by invoking the first plugin in a case that the evaluation data exceeds a corresponding preset threshold.

In an embodiment of the present disclosure, the progress quantification data includes at least one of: progress indication data, in which the progress indication data indicates whether the target task makes progress within a preset time period; improvement amplitude data, in which the improvement amplitude data includes an improvement amplitude value of the current task processing result of the target task; or processing efficiency data, in which the processing efficiency data includes a current processing efficiency of the target task; and the corresponding trigger condition of the progress quantification data includes at least one of: the progress indication data indicating that the target task makes no progress within the preset time period; the improvement amplitude value indicated by the improvement amplitude data being lower than a preset amplitude threshold; or the processing efficiency data indicating that a processing efficiency of the target task is decreased.

In an embodiment of the present disclosure, the second determination module 503 includes: a third obtaining unit, configured to, in response to completing the execution of the step to which the second plugin subscribes, obtain second task data of the target task by invoking the second plugin; a fourth obtaining unit, configured to obtain state information of the target task according to the second task data by invoking the second plugin, in which the state information includes at least one of: statistics of target task data during the execution process of the target task, a feedback result of a current task processing result of the target task, or problem domain information of the target task; and a second determination unit, configured to determine whether to trigger training of the large model according to the state information by invoking the second plugin.

In an embodiment of the present disclosure, the second determination unit is further configured to: determine to trigger training of the large model by invoking the second plugin in a case that the state information satisfies at least one of: the statistics of the target task data during the execution process of the target task exceeding a preset statistic threshold; the feedback result of the current task processing result of the target task indicating that an execution success rate of the current task processing result is lower than a preset success rate threshold; or the problem domain information of the target task indicating that a problem domain of the target task is changed.

In an embodiment of the present disclosure, the target task is a scientific research task; and the apparatus further includes a processing module, configured to: determine, from historical data related to the scientific research task, target scientific research data that matches a research objective of the target task; and generate the task processing result by invoking the large model to perform simulation reasoning based on the target scientific research data.

In an embodiment of the present disclosure, the processing module is further configured to: determine similarities between pieces of scientific research data in the historical data and the research objective; take a piece of scientific research data in the historical data whose similarity is higher than a preset similarity threshold as the target scientific research data; and/or determine evaluation scores by performing value evaluation on pieces of scientific research data in the historical data according to the research objective; and take a piece of scientific research data in the historical data whose evaluation score is higher than a preset score threshold as the target scientific research data.

In an embodiment of the present disclosure, the processing module is further configured to: obtain an execution feedback result or a simulation feedback result of the task processing result; and take the execution feedback result or the simulation feedback result as the feedback result of the task processing result.

In an embodiment of the present disclosure, the apparatus further includes: a sending module, configured to, in response to determining to trigger the expert participation in decision-making via the first plugin, send target data to a target client by invoking the first plugin, in which the target data includes the task processing result generated during any round of task processing and basic data on which the task processing result depends; and a receiving module, configured to receive modification data and/or guidance data sent by the target client by invoking the first plugin, in which the modification data is obtained by modifying the target data, the guidance data is determined based on the target data, and the guidance data is used to guide a task processing process of the target task.

In an embodiment of the present disclosure, the processing module is further configured to: record the task processing result generated during any round of task processing, basic data on which the task processing result depends, and the feedback result of the task processing result, and the apparatus further includes: a construction module, configured to in response to completing the execution of the step to which the second plugin subscribes, construct a training sample pair of the large model based on a recorded task processing result, the basic data on which the task processing result depends, and the feedback result of the task processing result by invoking the second plugin; and a training module, configured to in response to determining to trigger training of the large model via the second plugin, training the large model based on the training sample pair by invoking the second plugin.

In the apparatus for processing a plugin-based task provided in the embodiments of the present disclosure, by registering the first plugin and the second plugin in the execution process of the target task, modular access of functions may be achieved, which improves the system scalability and reusability; in which the first or second plugin is triggered to be invoked after the execution of the step to which the first or second plugin subscribes is completed, which may decouple functions implemented by the plugins from the task execution process, and avoid the rigidity caused by hard coding; the first plugin dynamically judges whether to trigger the expert participation in decision-making according to the first running state of the target task, which may achieve on-demand and flexible human-in-the-loop, both integrating prior knowledge for experts in the field and avoiding unnecessary manual intervention, and may improve the controllability and rationality of target task execution; the second plugin dynamically judges whether to trigger training of the large model according to the second running state of the target task, which may decouple model training from the fixed model calling process, enable adaptive triggering of model optimization based on an actual execution status of the task, enhance the generalization ability and robustness of the large model for different task scenarios, and improve the efficiency and credibility of the target task execution.

In the technical solution of the present disclosure, acquisition, storage, application, etc. of user personal information involved comply with relevant laws and regulations and do not violate public order and good customs.

According to the embodiments of the present disclosure, the present disclosure also provides an electronic device, a readable storage medium, and a computer program product.

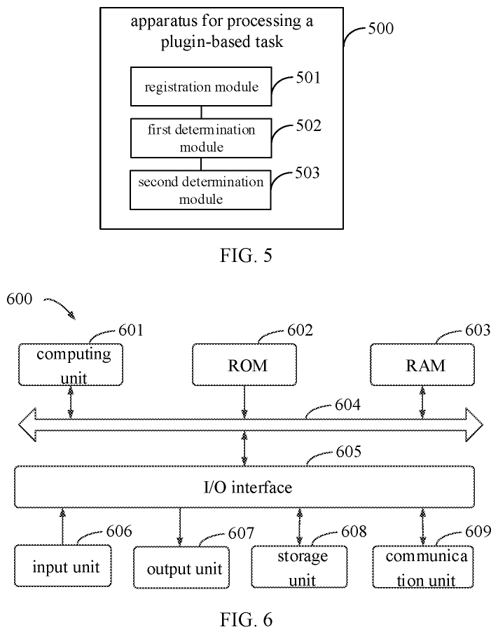

FIG. 6 is a block diagram illustrating an example electronic device 600 that may be used to implement the embodiments of the present disclosure. The electronic device is intended to represent various types of digital computers, such as laptop computers, desktop computers, workstations, personal digital assistants, servers, blade servers, mainframe computers, and other suitable computers. The electronic device may also represent various types of mobile devices, such as personal digital assistants, cellular phones, smart phones, wearable devices, and other similar computing devices. The components shown herein, their connections and relations, and their functions are merely examples, which are not intended to limit the implementations of the disclosure described and/or required herein.

As shown in FIG. 6, the device 600 includes a computing unit 601, configured to execute various appropriate actions and processes according to a computer program/instruction stored in a read-only memory (ROM) 602 or a computer program/instruction loaded from a storage unit 608 to a random access memory (RAM) 603. The RAM 603 may store various programs and data required for an operation of the device 600. The computing unit 601, the ROM 602 and the RAM 603 may be connected with each other via buses 604. An input/output (I/O) interface 605 is also connected to the bus 604.

The plurality of components in the device 600 are connected to the I/O interface 605, including: an input unit 606, for example, a keyboard, a mouse, etc.; an output unit 607, for example, various types of displays, speakers, etc.; a storage unit 608, for example, a magnetic disk, an optical disk, etc.; and a communication unit 609, for example, a network card, a modem, a wireless transceiver, etc. The communication unit 609 allows the device 600 to exchange information/data via a computer network such as Internet and/or various types of telecommunication networks with other devices.

The computing unit 601 may be various types of general and/or dedicated processing components with processing and computing abilities. Some examples of the computing unit 601 include but not limited to a central processing unit (CPU), a graphics processing unit (GPU), various dedicated artificial intelligence (AI) computing chips, various computing units on which a machine learning model algorithm is running, a digital signal processor (DSP), and any appropriate processor, controller, microcontroller, etc. The computing unit 601 executes various methods and processes as described above, for example, a method for processing a plugin-based task. For example, in some embodiments, the method for processing a plugin-based task may be further implemented as a computer software program, which is tangibly included in a machine readable medium, such as the storage unit 608. In some embodiments, a part or all of the computer program/instructions may be loaded and/or installed on the device 600 via the ROM 602 and/or the communication unit 609. When the computer program is loaded on the RAM 603 and executed by the computing unit 601, one or more steps in the method for processing a plugin-based task may be performed as described above. In other embodiments, the computing unit 601 may be configured to implement the method for processing a plugin-based task in other appropriate ways (for example, by means of a firmware).

The implementations of the systems and techniques described above may be implemented by one and/or a combination of a digital electronic circuit system, an integrated circuit system, a field-programmable gate array (FPGA), an application specific integrated circuit (ASIC), an application specific standard product (ASSP), a system on chip (SoC), a complex programmable logic device (CPLD), computer hardware, firmware, and software. These embodiments may be implemented in one or more computer programs/instructions, in which the one or more computer programs/instructions that may be executed and/or interpreted on a programmable system including at least one programmable processor, which may be a dedicated or general programmable processor for receiving data and instructions from a storage system, at least one input device and at least one output device, and transmitting the data and the instructions to the storage system, the at least one input device and the at least one output device.

The program code configured to implement the method of the disclosure may be written in any combination of one or more programming languages. These program codes may be provided for processors or controllers of general-purpose computers, dedicated computers, or other programmable data processing devices, so that the program codes, when executed by the processors or the controllers, enable the functions/operations specified in the flowcharts and/or the block diagrams to be performed. The program code may be entirely executed on a machine, partly executed on a machine, partly executed on a machine and partly executed on a remote machine as an independent software package, or entirely executed on a remote machine or a server.

In the context of the disclosure, a machine-readable medium may be a tangible medium that may include or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, RAMs, ROMs, electrically programmable read-only memories (EPROMs), flash memories, fiber optics, compact disc read-only memories (CD-ROMs), optical storage devices, magnetic storage devices, or any suitable combination of the foregoing.

In order to provide interaction with a user, the systems and techniques described herein may be implemented on a computer having a display device (e.g., a cathode ray tube (CRT) or a liquid crystal display (LCD) monitor) for displaying information to a user; and a keyboard and a pointing device (such as a mouse or trackball) via which the user may provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or haptic input).

The systems and technologies described herein may be implemented in a computing system that includes background components (e.g., a data server), or a computing system that includes middleware components (e.g., an application server), or a computing system that includes front-end components (e.g., a user computer with a graphical user interface or a web browser, via which the user may interact with the implementations of the systems and technologies described herein), or may include any combination of the background components, the middleware components, and the front-end components. The components of the system may be interconnected by any form or medium of digital data communication (e.g., a communication network). Examples of the communication network include: the local area network (LAN), the wide area network (WAN), the Internet, and the blockchain network.

The computer system may include a client and a server. The client and server are generally remote from each other and interacting via a communication network. A relationship between the client and the server is generated by computer programs/instructions running on corresponding computers and having a client-server relationship with each other. The server may be a cloud server, a server of a distributed system, or a server combined with a block chain.

It may be understood that various forms of processes shown above may be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions may be made according to design requirements and other factors.

1. A method for processing a plugin-based task in an intelligent machine learning algorithm design, comprising:
registering a first plugin and a second plugin in an execution process of a target task, wherein the execution process of the target task comprises generating a task processing result based on historical data related to the target task and a large model, and performing a next round of task processing based on a feedback result of the task processing result;
in response to completing execution of a step to which the first plugin subscribes, determining whether to trigger expert participation in decision-making according to a first running state of the target task by invoking the first plugin; and
in response to completing execution of a step to which the second plugin subscribes, determining whether to trigger training of the large model according to a second running state of the target task by invoking the second plugin.

2. The method of claim 1, wherein determining whether to trigger the expert participation in decision-making comprises:
in response to completing the execution of the step to which the first plugin subscribes, obtaining first task data of the target task by invoking the first plugin;
obtaining at least one of progress quantification data or evaluation data of the target task according to the first task data by invoking the first plugin, wherein the progress quantification data is used to quantify a progress state of the target task, and the evaluation data comprises an uncertainty indicator of a current task processing result of the target task; and
determining whether to trigger the expert participation in decision-making according to the at least one of the progress quantification data or the evaluation data by invoking the first plugin.

3. The method of claim 2, wherein determining whether to trigger the expert participation in decision-making according to the at least one of the progress quantification data or the evaluation data by invoking the first plugin comprises at least one of:
determining to trigger the expert participation in decision-making by invoking the first plugin in a case that the progress quantification data satisfies a corresponding trigger condition; or
determining to trigger the expert participation in decision-making by invoking the first plugin in a case that the evaluation data exceeds a corresponding preset threshold.

4. The method of claim 3, wherein the progress quantification data comprises at least one of:
progress indication data, wherein the progress indication data indicates whether the target task makes progress within a preset time period;
improvement amplitude data, wherein the improvement amplitude data comprises an improvement amplitude value of the current task processing result of the target task; or
processing efficiency data, wherein the processing efficiency data comprises a current processing efficiency of the target task; and
the corresponding trigger condition of the progress quantification data comprises at least one of:
the progress indication data indicating that the target task makes no progress within the preset time period;
the improvement amplitude value indicated by the improvement amplitude data being lower than a preset amplitude threshold; or
the processing efficiency data indicating that a processing efficiency of the target task is decreased.

5. The method of claim 1, wherein determining whether to trigger training of the large model comprises:
in response to completing the execution of the step to which the second plugin subscribes, obtaining second task data of the target task by invoking the second plugin;
obtaining state information of the target task according to the second task data by invoking the second plugin, wherein the state information comprises at least one of: statistics of target task data during the execution process of the target task, a feedback result of a current task processing result of the target task, or problem domain information of the target task; and
determining whether to trigger training of the large model according to the state information by invoking the second plugin.

6. The method of claim 5, wherein determining whether to trigger training of the large model according to the state information by invoking the second plugin comprises:
determining to trigger training of the large model by invoking the second plugin in a case that the state information satisfies at least one of:
the statistics of the target task data during the execution process of the target task exceeding a preset statistic threshold;
the feedback result of the current task processing result of the target task indicating that an execution success rate of the current task processing result is lower than a preset success rate threshold; or
the problem domain information of the target task indicating that a problem domain of the target task is changed.

7. The method of claim 1, wherein the target task is a scientific research task; and generating the task processing result based on the historical data related to the target task and the large model comprises:
determining, from historical data related to the scientific research task, target scientific research data that matches a research objective of the target task; and
generating the task processing result by invoking the large model to perform simulation reasoning based on the target scientific research data.

8. The method of claim 7, wherein determining, from the historical data related to the scientific research task, the target scientific research data that matches the research objective of the target task comprises:
determining similarities between pieces of scientific research data in the historical data and the research objective;
taking a piece of scientific research data in the historical data whose similarity is higher than a preset similarity threshold as the target scientific research data; and/or
determining evaluation scores by performing value evaluation on pieces of scientific research data in the historical data according to the research objective; and
taking a piece of scientific research data in the historical data whose evaluation score is higher than a preset score threshold as the target scientific research data.

9. The method of claim 1, wherein the execution process of the target task further comprises:
obtaining an execution feedback result or a simulation feedback result of the task processing result; and
taking the execution feedback result or the simulation feedback result as the feedback result of the task processing result.

10. The method of claim 1, further comprising:
in response to determining to trigger the expert participation in decision-making via the first plugin, sending target data to a target client by invoking the first plugin, wherein the target data comprises the task processing result generated during any round of task processing and basic data on which the task processing result depends; and
receiving at least one of modification data or guidance data sent by the target client by invoking the first plugin, wherein the modification data is obtained by modifying the target data, the guidance data is determined based on the target data, and the guidance data is used to guide a task processing process of the target task.

11. The method of claim 1, wherein the execution process of the target task further comprises:
recording the task processing result generated during any round of task processing, basic data on which the task processing result depends, and the feedback result of the task processing result, and the method further comprises:
in response to completing the execution of the step to which the second plugin subscribes, construct a training sample pair of the large model based on a recorded task processing result, the basic data on which the task processing result depends, and the feedback result of the task processing result by invoking the second plugin; and
in response to determining to trigger training of the large model via the second plugin, training the large model based on the training sample pair by invoking the second plugin.

12. An electronic device in an intelligent machine learning algorithm design, comprising:
at least one processor; and
a memory communicatively coupled to the at least one processor, wherein
the memory stores instructions that, when executable by the at least one processor, cause the at least one processor to:
register a first plugin and a second plugin in an execution process of a target task, wherein the execution process of the target task comprises generating a task processing result based on historical data related to the target task and a large model, and perform a next round of task processing based on a feedback result of the task processing result;
in response to completing execution of a step to which the first plugin subscribes, determine whether to trigger expert participation in decision-making according to a first running state of the target task by invoking the first plugin; and
in response to completing execution of a step to which the second plugin subscribes, determine whether to trigger training of the large model according to a second running state of the target task by invoking the second plugin.

13. The electronic device of claim 12, wherein the at least one processor is further configured to:
in response to completing the execution of the step to which the first plugin subscribes, obtain first task data of the target task by invoking the first plugin;
obtain at least one of progress quantification data or evaluation data of the target task according to the first task data by invoking the first plugin, wherein the progress quantification data is used to quantify a progress state of the target task, and the evaluation data comprises an uncertainty indicator of a current task processing result of the target task; and
determine whether to trigger the expert participation in decision-making according to the at least one of the progress quantification data or the evaluation data by invoking the first plugin.

14. The electronic device of claim 13, wherein the at least one processor is further configured to:
determine to trigger the expert participation in decision-making by invoking the first plugin in a case that the progress quantification data satisfies a corresponding trigger condition; or
determine to trigger the expert participation in decision-making by invoking the first plugin in a case that the evaluation data exceeds a corresponding preset threshold.

15. The electronic device of claim 14, wherein the progress quantification data comprises at least one of:
progress indication data, wherein the progress indication data indicates whether the target task makes progress within a preset time period;
improvement amplitude data, wherein the improvement amplitude data comprises an improvement amplitude value of the current task processing result of the target task; or
processing efficiency data, wherein the processing efficiency data comprises a current processing efficiency of the target task; and
the corresponding trigger condition of the progress quantification data comprises at least one of:
the progress indication data indicating that the target task makes no progress within the preset time period;
the improvement amplitude value indicated by the improvement amplitude data being lower than a preset amplitude threshold; or
the processing efficiency data indicating that a processing efficiency of the target task is decreased.

16. The electronic device of claim 12, wherein the at least one processor is further configured to:
in response to completing the execution of the step to which the second plugin subscribes, obtain second task data of the target task by invoking the second plugin;
obtain state information of the target task according to the second task data by invoking the second plugin, wherein the state information comprises at least one of: statistics of target task data during the execution process of the target task, a feedback result of a current task processing result of the target task, or problem domain information of the target task; and
determine whether to trigger training of the large model according to the state information by invoking the second plugin.

17. The electronic device of claim 16, wherein the at least one processor is further configured to:
determine to trigger training of the large model by invoking the second plugin in a case that the state information satisfies at least one of:
the statistics of the target task data during the execution process of the target task exceeding a preset statistic threshold;
the feedback result of the current task processing result of the target task indicating that an execution success rate of the current task processing result is lower than a preset success rate threshold; or
the problem domain information of the target task indicating that a problem domain of the target task is changed.

18. The electronic device of claim 12, wherein the target task is a scientific research task; and the at least one processor is further configured to:
determine, from historical data related to the scientific research task, target scientific research data that matches a research objective of the target task; and
generate the task processing result by invoking the large model to perform simulation reasoning based on the target scientific research data.

19. The electronic device of claim 18, wherein the at least one processor is further configured to:
determine similarities between pieces of scientific research data in the historical data and the research objective;
take a piece of scientific research data in the historical data whose similarity is higher than a preset similarity threshold as the target scientific research data; and/or
determine evaluation scores by performing value evaluation on pieces of scientific research data in the historical data according to the research objective; and
take a piece of scientific research data in the historical data whose evaluation score is higher than a preset score threshold as the target scientific research data.

20. A non-transitory computer-readable storage medium for storing computer instructions, wherein the computer instruction is configured to cause a computer to:
registering a first plugin and a second plugin in an execution process of a target task, wherein the execution process of the target task comprises generating a task processing result based on historical data related to the target task and a large model, and performing a next round of task processing based on a feedback result of the task processing result;
in response to completing execution of a step to which the first plugin subscribes, determining whether to trigger expert participation in decision-making according to a first running state of the target task by invoking the first plugin; and
in response to completing execution of a step to which the second plugin subscribes, determining whether to trigger training of the large model according to a second running state of the target task by invoking the second plugin.
